(19) United States
(12) Patent Application Publication
(10) Pub. No.: US 2002/0136455 A1
(43) Pub. Date: Sep. 26, 2002

(54) System and method for robust foreground and background image data separation for location of objects in front of a controllable display within a camera view

(76) Inventors: I-Jong Lin, Redwood City, CA (US); Nelson Liang An Chang, Palo Alto, CA (US)

Correspondence Address: HEWLETT-PACKARD COMPANY, Intellectual Property Administration, P.O. Box 272400, Fort Collins, CO, 80527-2400, US

(21) Appl. No.: 09/775,032

(22) Filed: Jan. 31, 2001

(51) Int. Cl. G06K 9/34; G06K 9/68; G06K 9/36

(52) U.S. Cl. 382/173; 382/218; 382/291

(57) ABSTRACT

System and method of locating objects positioned in front of a user interactive, computer controlled display area performed by calibrating the system to obtain a coordinate location mapping function and an intensity mapping function between the display area and the captured display area in the capture area of an image capture device. Once calibrated, objects can be located during real-time system operation by converting display area image data using the mapping functions to obtain expected captured display area data, capturing the display area image to obtain actual captured display area data, and comparing the expected and actual data to determine the location of objects in front of the display area in the capture area.

### FIELD OF THE INVENTION

The present invention relates to a computer controllable display system and in particular to the interaction of a user with a computer controlled displayed image.

### BACKGROUND OF THE INVENTION

Computer controlled projection systems generally include a computer system for generating image data and a projector for projecting the image data onto a projection screen. Typically, the computer controlled projection system is used to allow a presenter to project presentations that were created with the computer system onto a larger screen so that more than one viewer can easily see the presentation. Often, the presenter interacts with the projected image by pointing to notable areas on the projected image with his/her finger, laser pointer, or some other pointing device or instrument.

The problem with this type of system is that if a user wants to cause any change to the projected image, he/she must interact with the computer system using an input device such as a mouse, keyboard or remote device. For instance, a device is often employed by a presenter to remotely control the computer system via infrared signals to display the next slide in a presentation. However, this can be distracting to the viewers of the presentation since the presenter is no longer interacting with them and the projected presentation and, instead, is interacting with the computer system. Often, this interaction can lead to significant interruptions in the presentation.

Hence, a variation of the above system developed to overcome the computer- only interaction problem allows the presenter to directly interact with the projected image and thus better interaction with the audience. In this system, the computer generates image data (e.g. presentation slides) to be projected onto a projection screen with an image projector. The system also includes a digital image capture device such as a digital camera for capturing the projected image. The captured projected image data is transmitted back to the computing system and is used to determine the location of any objects (e.g., pointing device) in front of the screen. The computer system may then be controlled dependent on the determined location of the pointing device. For instance, in U.S. Pat. No. 5,138,304 assigned to the assignee of the subject application, a light beam is projected onto the screen and is detected by a camera. To determine the position of the light beam, the captured image data of the projected image and the original image data are compared. The computer is then caused to position a cursor in the video image at the pointer position or is caused to modify the projected image data in response to the pointer position.

In order to implement a user interactive, computer controlled display or projection system, it must be initially calibrated so as to determine the location of the screen (i.e., the area in which the image is displayed) within the capture area of the camera. Once the location of the screen is determined, this information can be used to identify objects within the capture area that are within the display area but are not part of the displayed image (e.g., objects in front of the display area). For instance, the system can identify a pointer or finger in front of the display area and its location within the display area. Knowing where objects are located in front of the display area can be used to cause the system to respond to the object dependent on its location within the display area.

In one known technique described in U.S. Pat. No. 5,940,139, the foreground and the background of a video are separated by illuminating the foreground with a visible light and the background with a combination of infrared and visible light and using two different cameras to pick of the signal and extract the background from the foreground. In another known technique described in U.S. Pat. No. 5,345,308, a man-made object is discriminated within a video signal by using a polarizer mounted to a video camera. The man-made object has both vertical and horizontal surfaces that reflect light that can be polarized whereas, backgrounds do not have polarizing components. Thus, the man-made object is filtered from the video signal. These techniques are cumbersome in that they require additional illumination methods, different types of cameras or filtering hardware and thus are not conducive to exact object location or real-time operation in slide presentation applications.

In still another known technique described in U.S. Pat. No. 5,835,078, an infrared pointer is projected on a large screen display device, and the identity and location of the infrared pointer are determined. Specialized infrared pointing devices emit frequencies unique to each device. The identity and location of a given pointer is detected by detecting its frequency using an infrared camera. The identity and location of the pointer are then used to cause the computer system to display a mark corresponding to the given pointer on the large screen display at the point at which the infrared pointer is positioned. Although this technique identifies the location of an object projected on a display screen, it requires the use of specialized equipment including infrared pointers and infrared cameras. Moreover it relies upon the simple process of detecting infrared light on a displayed image. In contrast, the separation of a physical object in the foreground of a displayed image requires the actual separation of image data corresponding to the object from image data corresponding to the background of the object (i.e., foreground and background image separation).

The present invention is a technique for separating foreground and background image data of a display area within the capture area of an image capture device in a user interactive, computer controlled display system.

### SUMMARY OF THE INVENTION

A system and method of locating objects positioned in front of a user interactive, computer controlled display area includes a computer system for displaying an image in the display area, means for converting the displayed image data into expected captured display area data using a derived coordinate location mapping function and a derived intensity mapping function, an image capture device for capturing the image in an image capture area to obtain captured data that includes captured display area data corresponding to a predetermined location of the display area in the capture area, and means for comparing the expected captured display area data to the captured display area data at each coordinate location of the captured display area data, such that non-matching compared image data corresponds to pixel locations of objects in front of the display area.

In another embodiment of the system including a computer controlled display area, the system is calibrated by displaying a plurality of calibration images within the display area each including a calibration object, capturing a plurality of images within the capture area each including one of the plurality of calibration images, determining a mapping between the coordinate location of the calibration object in the display area and the coordinate location of the calibration object in the capture area for each captured image, and deriving a coordinate location mapping function from the location mappings of the plurality of captured images.

In another embodiment, the system is further calibrated by displaying at least two intensity calibration objects having different displayed intensity values within the display area, capturing the intensity calibration objects within the capture area to obtain captured intensity values corresponding to the displayed intensity values, mapping the displayed intensity values to the captured intensity values, and deriving an intensity mapping function from the mappings between the displayed and captured intensity values.

### BRIEF DESCRIPTION OF THE DRAWINGS

FIG. 1 illustrates a block diagram of a first embodiment of a system for locating objects in front of a display area in a user interactive, computer controlled display system in accordance with the present invention;

FIG. 2A illustrates a first embodiment of the method of locating objects in front of a display area within a capture area in a user interactive, computer controlled display system in accordance with the present invention;

FIG. 2B illustrates converting display area image data into expected captured display area image data;

FIG. 2C illustrates identifying captured display area image data using predetermined display area location information;

FIG. 2D illustrates comparing expected captured display area image data to captured display area image data;

FIG. 3 shows a capture area including an image of a display area and a hand positioned in front of the display area;

FIG. 4 shows image data showing the location of the hand in the capture area illustrated in FIG. 3 obtained by performing the method illustrated in FIG. 2A in accordance with the present invention;

FIG. 5A illustrates a method of deriving a coordinate location function in accordance with the present invention;

FIG. 5B illustrates a calibration image including a calibration object;

FIG. 5C illustrates mapping the coordinate location of the calibration object in the displayed image coordinate system to the coordinate system of the captured displayed image; and

FIG. 6 shows a method of deriving an intensity mapping function in accordance with the present invention.

### DETAILED DESCRIPTION OF THE INVENTION

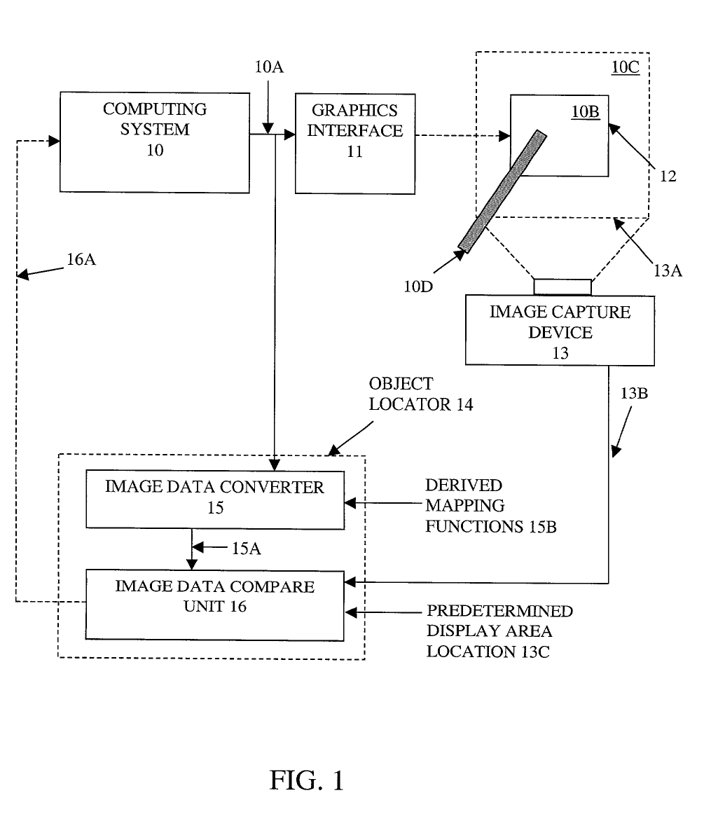

A block diagram of a user interactive, computer controlled image display system is shown in FIG. 1 including a computing system 10 for generating image data 10A and a graphical interface 11 for causing images 10B corresponding to the image data 10A to be displayed in display area 12. It should be understood that the graphical interface may be a portion of the computing system or may be a distinct element external to the computing system. The system further includes an image capture device 13 having an associated image capture area 13A for capturing displayed images 10B. The captured images also include images 10C of objects or regions that are outside of the display area 10B. The captured images can also include objects 10D that are positioned within the image capture area 13A in front of the display area 12. Non-display area images include anything other than what is displayed within the display area in response to image data 10A, including objects that extend into the display area. The captured images are converted into digital image data 13B and are transmitted to an object locator 14. Object locator 14 includes an image data converter 15 and an image data compare unit 16. The image data converter 15 converts display area image data 10A generated by the computing system into expected captured display area image data 15A using a derived coordinate location function and an intensity mapping function 15B. The expected image data 15A are coupled to image data compare unit 16 along with captured image data 13B and predetermined display area location information 13C. The image data compare unit 16 compares the expected captured display area image data 15A to the portion of the captured image data 13B that corresponds to the display area in the predetermined display area location. Non-matching compared data corresponds to the pixel locations in the captured display area image data 13B where an object is located. The object location information 16A can be transmitted to the computing system 10 for use in the user interactive, computer controlled display system.

In this embodiment, the computing system 10 includes at least a central processing unit (CPU) and a memory for storing digital data (e.g., image data) and has the capability of generating at least three levels of grayscale images. The display area can be a computer monitor driven by the graphical interface or can be an area on a projection screen or projection area (e.g., a wall). In the case in which images are displayed using projection, the system includes an image projector (not shown in FIG. 1) that is responsive to image data provided from the graphical interface.

In one embodiment, the image capture device is a digital still or video camera or digital video camera arranged so as to capture at least all of the images 10B displayed in the display area 12 within a known time delay. It is well known in the field of digital image capture that an image is captured by a digital camera using an array of sensors that detect the intensity of the light impinging on the sensors within the capture area of the camera. The light intensity signals are then converted into digital image data corresponding to the captured image. Hence, the captured image data 13B is digital image data corresponding to the captured image. In another embodiment the image capture device is an analog still or video camera and captured analog image data is converted into captured digital image data 13B.

In one embodiment, the images 10B correspond to a plurality of slides in a user's computer generated slide presentation.

It should be noted that a single conversion of the displayed image data into expected captured image data is required per displayed image. However, more than one comparison can be performed per displayed image so as to detect the movement and location of non-static objects positioned in front of the displayed image. For instance, while a single image is displayed it can be captured by image capture device 13 on a continual basis and each new captured image can be compared by image data compare unit 16 to the expected captured image data to locate objects at different time intervals.

It should be understood that all or a portion of the functions of the object locator 14 can be performed by the computing system. Consequently, although it is shown external to the computing system, all or portions of the object locator 14 may be implemented within the computing system.

It should be further understood that the object locator can be implemented in a software implementation, hardware implementation, or any combination of software and hardware implementations.

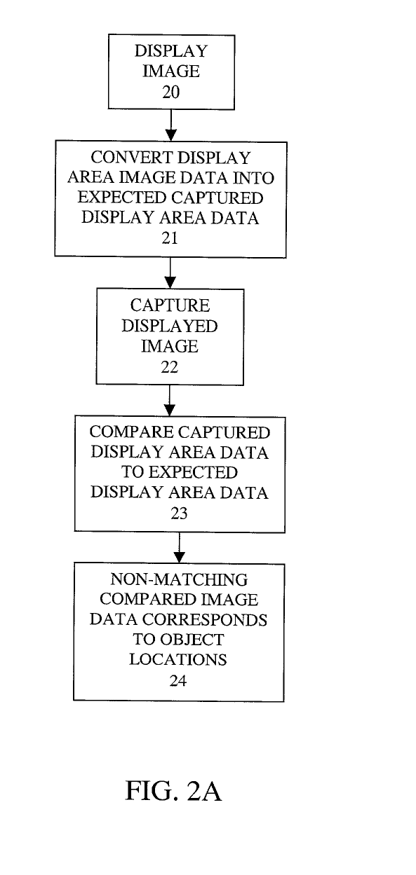

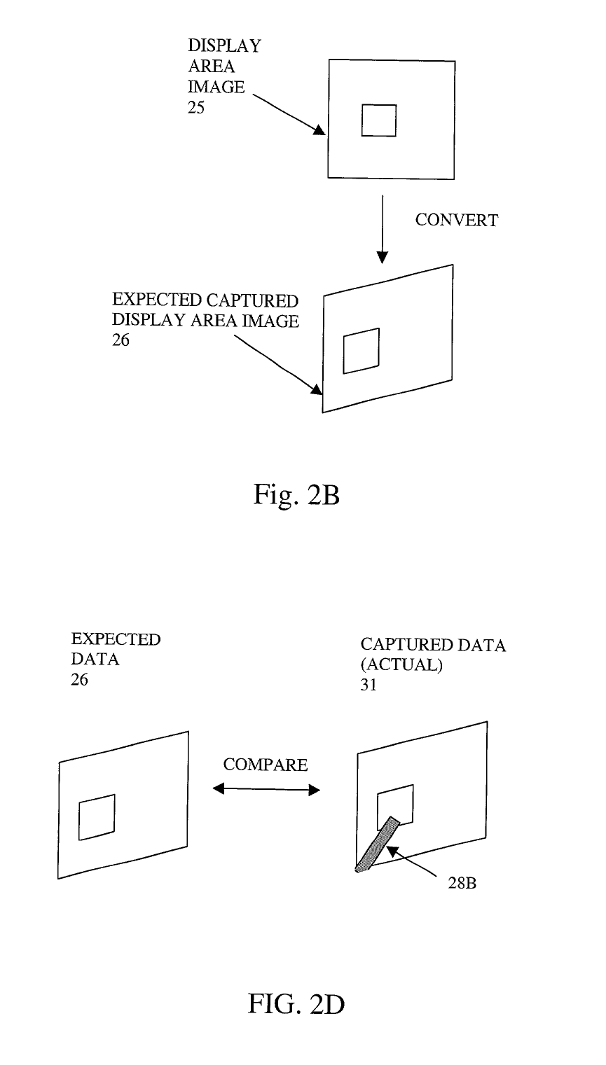

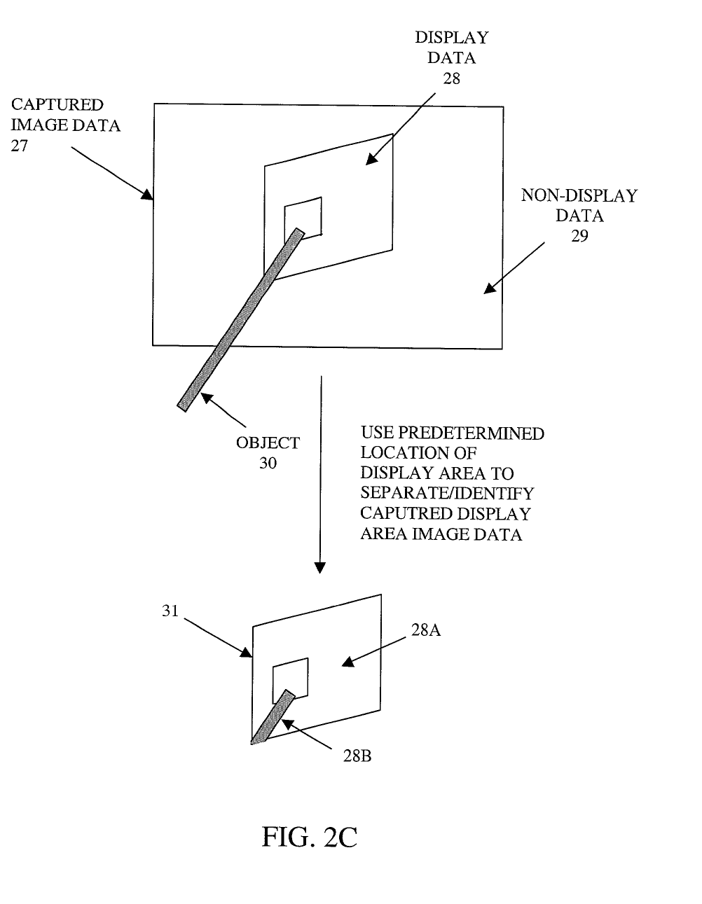

A first embodiment of a method for locating objects positioned in front of the display area 12 is shown in FIG. 2A. An image is displayed in the display area (block 20). The image can correspond to a current one of a plurality of images of a user's slide presentation being displayed during real-time use of the system shown in FIG. 1. It should be noted that the method as shown in FIG. 2A can be performed on each of the plurality of images (i.e., slides) of a slide presentation allowing the location of objects in front of the display area to be performed in real-time during the presentation.

The corresponding image data 10A (FIG. 1) employed by the computing system to display the image in the display area is converted into an expected captured display area data (block 21). The image data is converted using a derived coordinate location mapping function and a derived intensity mapping function. FIG. 2B illustrates the conversion of the display area image data to expected captured display area image data. The display area image 25 corresponds to the image data 10A generated by the computing system for either projecting or displaying an image. The image data 10A is converted using the derived coordinate location mapping function and intensity mapping function to generate data corresponding to the expected captured display area image 26.

The displayed image is captured in the capture area of an image capture device to obtain capture area image data (block 22). FIG. 2C shows the captured image data 27 that includes display area data 28 and non-display area image data 29. The display area data includes a portion of at least one object 30 that is located in front of the displayed image in the display area. As a result, the display area data includes image data corresponding to the portion of the object.

The location of the display area within the capture area is predetermined. This pre-determination can be performed during calibration of the system prior to real-time use of the user interactive, computer controlled display system. In one embodiment, the pre-determination of the location of the display area is performed according to the system and method as disclosed in application Ser. No. ______ (Attorney Docket No.: 10007846) incorporated herein by reference. Specifically, according to this method the location of the display area is determined by deriving constructive and destructive feedback data from image data corresponding to a plurality of captured calibration images. It should be understood that other methods of determining the location of the display area in the capture area can be used to perform the system and method of locating objects in front of a display screen in accordance with the present invention. The pre-determination of the location of the display screen in the capture area allows for the separation/identification of the captured display area data 31 from the captured image data 27 (FIG. 2C). In particular, as shown in FIG. 2C, the pre-determination of the location of the display area within the captured area allows for the separation/identification of only the display area data including both the displayed image data 28A and the data 28B corresponding to the portion of the object in front of the display area.

The expected captured display area data 26 is compared to the identified captured display area data 31 by comparing mapped pixel values (block 23, FIG. 2D). Non-matching pixel values indicate the location of the object in front of the display area (block 24). As shown in FIG. 2D, the object 28B represents non-matching pixel data thereby indicating an object in front of the display area.

It should be understood that although only a single conversion (block 21) of the displayed image data into expected captured image data is minimally required per displayed image, more than one comparison (block 23) can be performed per displayed image so as to detect the movement and location of non-static objects positioned in front of the displayed image. For instance, while a single image is displayed it can be captured (block 22) on a continual basis and compared (block 23) to the expected captured image data to locate objects at during different time intervals as the image is being displayed.

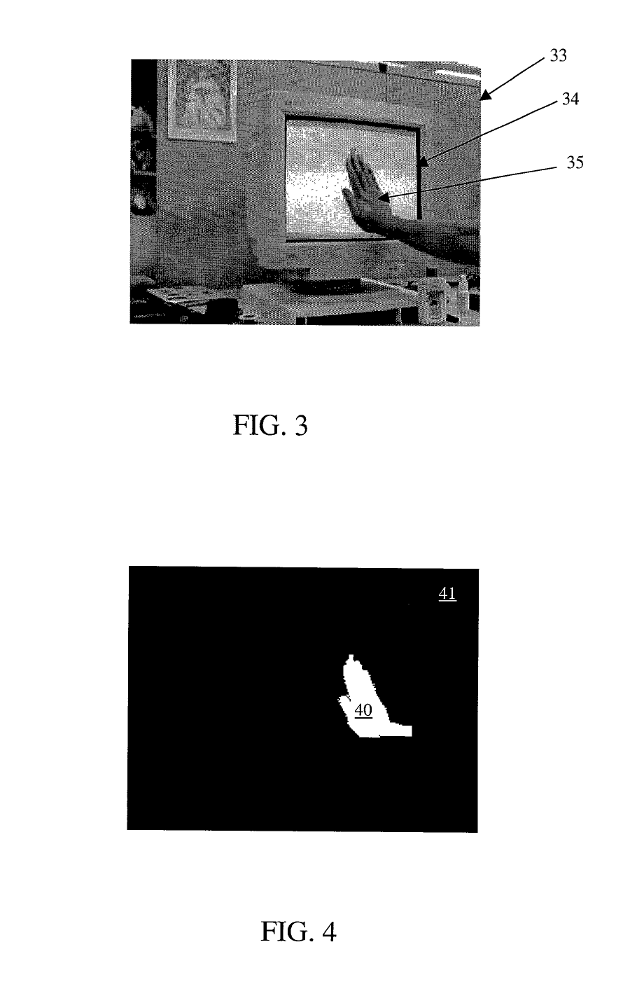

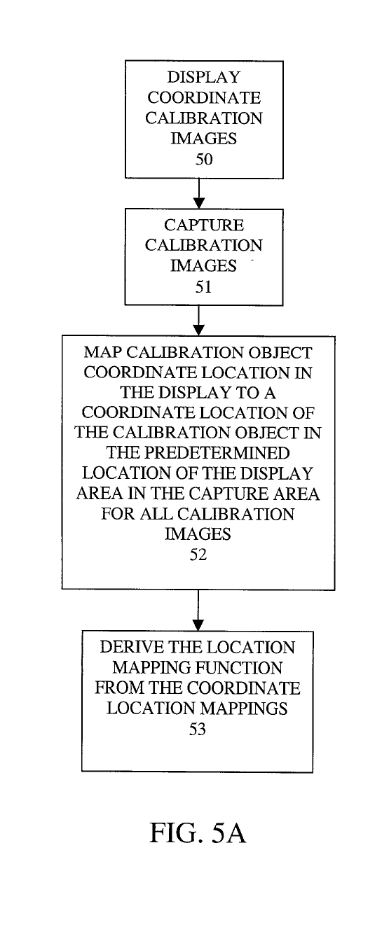

FIGS. 3 and 4 show images illustrating the method of locating objects in front of a user interactive, computer controlled display system as shown in FIG. 2A. In particular, FIG. 3 shows the capture area 33 having an image including a display area 34 and an object 35 (i.e., a hand) positioned in front of the display area 34. FIG. 4 shows data obtained using the method shown in FIG. 2A to locate the hand in front of the display. In this example, the method of FIG. 2A additionally modifies the captured image data to show the location of the hand in front of the display area within the capture area by setting the pixel values (i.e., intensity values) at the coordinate locations 40 of the hand to one intensity value (e.g., white) and pixel values at the coordinate locations 41 where no objects are detected to a different intensity value (e.g., black).

In accordance with the method shown in FIG. 2A, captured display area data can be compared to expected display area data by subtracting the expected captured display area data (expected data) from the captured display area data (actual data) to obtain a difference value:

δ(uᵢ, vᵢ)=||ExpectedData(uᵢ, vᵢ)−ActualData(uᵢ, vᵢ)|| Eq. 1

where (uᵢ, vᵢ) are the coordinate locations in the capture display area. The difference value δ(uᵢ, vᵢ) is then compared to a threshold value, cₜₕᵣₑₛₕ, where cₜₕᵣₑₛₕ is a constant determined by the lighting conditions, image that is displayed, and camera quality. If the difference value is greater than the threshold value (i.e., δ(uᵢ, vᵢ)>cₜₕᵣₑₛₕ) then an object exists at that coordinate point. In other words, the points on the display that do not meet the computer's intensity expected value at a given display area location have an object in the line of sight between the camera and the display.

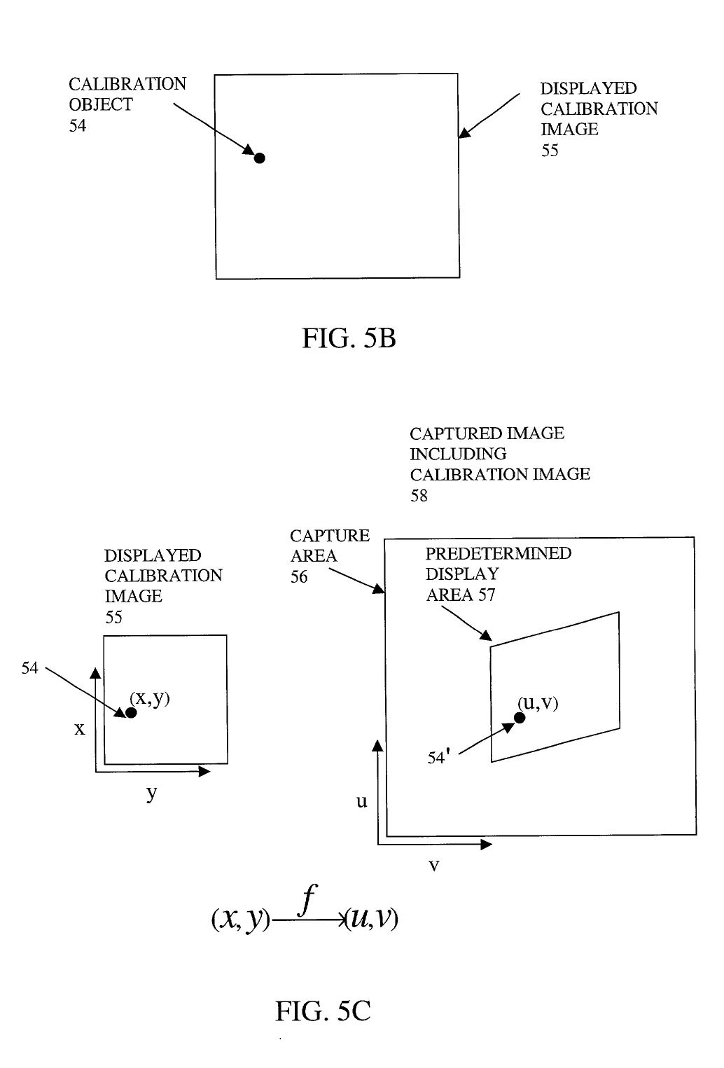

FIG. 5A shows a method of calibrating a system for locating objects positioned in front of a user interactive, computer controlled display area. Calibration is achieved by initially displaying a plurality of coordinate calibration images (block 50). FIG. 5B shows an example of a coordinate calibration image 55 that includes a calibration object 54. The calibration images are characterized in that the calibration object is located at a different location within each of the calibration images. It should be noted that the object does not have to be circular in shape and can take other shapes to implement the method of the subject application.

The plurality of calibration images is successively captured in the capture area such that each captured image includes one of the calibration objects (block 51). For each captured image, the coordinate location of the display area calibration object is mapped to a coordinate location of the calibration object in the predetermined location of the display area in the capture area (block 52). It should be noted that the coordinate location of the display area calibration object is known from image data 10A (FIG. 1) and the coordinate location of the calibration object in the capture area is known from capture data 13B.

As shown in FIG. 5C, the displayed calibration image 55 can be viewed as having an x-y coordinate system and the captured image 58 can be viewed as having a u-v coordinate system, thus allowing the mapping of an x-y coordinate location of the calibration object 54 to a u-v coordinate location of the captured object 54′.

The image data corresponding to the display area 57 in the capture area is identified by predetermining the location of the display area within the capture area. As described above, display area location pre-determination can be performed according to the system and method as disclosed in application Ser. No. ______ (Attorney Docket No.: 10007846) however other methods can be used. The pre-determination of the location of the display screen in the capture area allows for the identification of the captured display area data and hence the mapping of the x-y coordinate location of the displayed calibration object 54 to a u-v coordinate location of the captured calibration object 54′ in the predetermined display area.

The individual mappings of calibration object locations allow for the derivation of a function between the two coordinate systems (block 53):

$$( x , y ) {\to }^{f} ( u , v ) \qquad Eq . 2$$

In one embodiment, a perspective transformation function (Eqs. 3 and 4) is used to derive the location mapping function:

$$\begin{matrix}{f}_{u} ( x , y ) = u = \frac{{a}_{11} x + {a}_{21} y + {a}_{31}}{{a}_{13} x + {a}_{23} y + {a}_{33}} & Eq . 3 \\ {f}_{v} ( x , y ) = v = \frac{{a}_{12} x + {a}_{22} y + {a}_{32}}{{a}_{13} x + {a}_{23} y + {a}_{33}} & Eq . 4\end{matrix}$$

The variables αᵢⱼ of Eqs. 3 and 4 are derived by determining individual location mappings for each calibration object. It should be noted that other transformation functions can be used such as a simple translational mapping function or an affine mapping function.

For instance, for a given calibration object in a calibration image displayed within the display area, its corresponding x,y coordinates are known from the image data 10A generated by the computer system. In addition, the u,v coordinates of the same calibration object in the captured calibration image are also known from the portion of the captured image data 13B corresponding to the predetermined location of the display area in the capture area. The known x,y,u,v coordinate values are substituted into Eqs. 3 and 4 for the given calibration object. Each of the calibration objects in the plurality of calibration images are mapped in the same manner to obtain x and y calibration mapping equations (Eq. 3 and 4).

The location mappings of each calibration object are then used to derive the coordinate location functions (Eq. 3 and 4). Specifically, the calibration mapping equations are simultaneously solved to determine coefficients a₁₁-a₃₃ of transformation functions Eqs. 3 and 4. Once determined, the coefficients are substituted into Eqs. 3 and 4 such that for any given x,y coordinate location in the display area, a corresponding u-v coordinate location can be determined. It should be noted that an inverse mapping function from u-v coordinates to x,y coordinates can also be derived from the coefficients a₁₁-a₃₃.

In the case of a two-dimensional transformation function (e.g., Eqs. 3 and 4), nine coefficients (e.g., a₁₁-a₃₃) need to be determined and, hence at least nine equations are required. Since, there are two mapping equations per calibration image, at least five calibration images are required in order to solve for the function. It should be noted that more calibration objects may be used and this overconstrained problem (i.e., more calibration objects than required to solve for the coefficients) may be robustly approximated with LSQ (i.e., least square) fit.

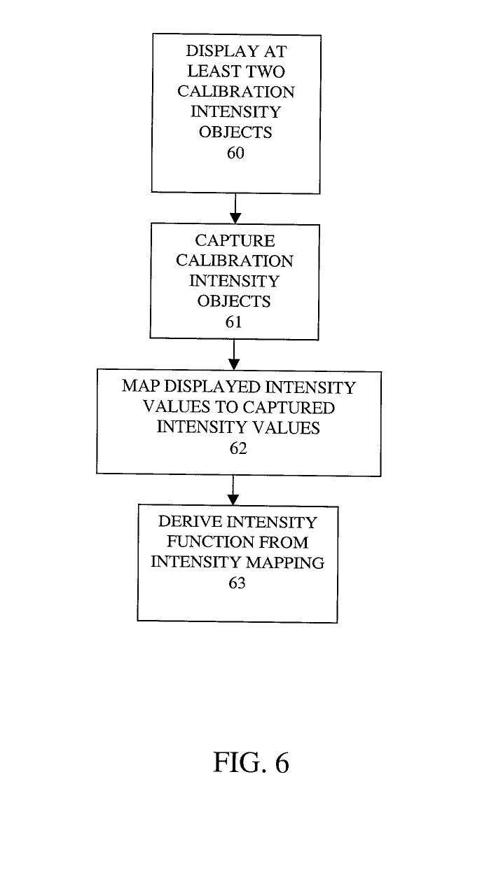

The method shown in FIG. 5A can further include the calibration method shown in FIG. 6 for determining an intensity mapping function. Calibration is achieved by displaying at least two intensity calibration objects having different intensity values from the other (block 60). The, at least, two intensity calibration objects may be displayed in separate images or with the same image. The, at least, two objects may be displayed at the same location or different locations within the image or images. The intensity calibration objects can be a color or a grayscale image object. The displayed intensity values of the displayed intensity calibration objects are known from the image data 10A generated by the computing system 10 (FIG. 1). The, at least, two calibration objects are captured (block 61) to obtain capture data 13B where the captured objects have associated captured intensity values corresponding to the displayed intensity values. The displayed intensity values are mapped to the captured intensity values (block 62). An intensity mapping function is derived from the, at least, two intensity mappings (block 63). It should be noted that the derived coordinate location mapping function is used to identify corresponding pixel locations between the display area and the captured display area to allow for intensity mapping between pixels at the corresponding locations.

In one embodiment, the intensity mapping function is determined using interpolation. For example, given the mappings between the displayed and captured intensity values, a range of displayed values and corresponding mapped captured values can be determined using linear interpolation. Captured and interpolated captured intensity values can then be stored in a look-up table such that when a displayed intensity value accesses the table, a corresponding mapped captured intensity value can be obtained. It should be noted that the mapping is not limited to linear interpolation and other higher order or non-linear interpolation methods can be employed.

Hence, the intensity and coordinate location mapping functions are determined so as to calculate ExpectedData(uᵢ, vᵢ) in Eq. 1. The absolute difference (i.e., δ(uᵢ, vᵢ)) between the ExpectedData(uᵢ, vᵢ) and ActualData(uᵢ,vᵢ) is then determined to locate the object in the display area of the captured data.

A system and method is described that provides an arithmetically non-complex solution to locating objects in front of a display area within the capture area of an image capture device in a user interactive, computer controlled display system. Specifically, a system is described whereas an image is displayed on a per frame basis and a simple series of operations are performed continuously to determine the location of the object(s) in front of the displayed image.

In the preceding description, numerous specific details are set forth, such as calibration image type and a perspective transformation function in order to provide a thorough understanding of the present invention. It will be apparent, however, to one skilled in the art that these specific details need not be employed to practice the present invention. In other instances, well-known image processing techniques have not been described in detail in order to avoid unnecessarily obscuring the present invention.

In addition, although elements of the present invention have been described in conjunction with certain embodiments, it is appreciated that the invention can be implement in a variety of other ways. Consequently, it is to be understood that the particular embodiments shown and described by way of illustration is in no way intended to be considered limiting. Reference to the details of these embodiments is not intended to limit the scope of the claims which themselves recited only those features regarded as essential to the invention.

We claim:

1. The method of locating objects positioned in front of a computer controlled display area, the method comprising:
displaying an image having corresponding image data in the display area;
converting the image data into expected captured display area data using a derived coordinate location function and a derived intensity function;
capturing the image in an image capture area to obtain captured data that includes captured display area data corresponding to a predetermined location of the display area in the capture area;
comparing the expected captured display area data to the captured display area data;
wherein non-matching compared image data locations correspond to locations of the objects.

2. The method as described in claim 1 further comprising deriving the coordinate location function by:
displaying a plurality of calibration images within the display area each including a calibration object having an associated coordinate location within the display area;
capturing a plurality of images of the display area within the capture area each including one of the plurality of calibration images;
for each captured image, mapping the coordinate location of the calibration object in the display area to a coordinate location of the calibration object in the predetermined location of the display area in the capture area; and
deriving the location function from the display area to the captured display area from the coordinate location mappings.

3. The method as described in claim 2 further comprising deriving the intensity function by:
displaying at least two intensity calibration objects in at least one image within the display area each having a different associated displayed intensity value;
capturing the at least two displayed objects in the at least one image to obtain captured intensity values corresponding to the displayed intensity values;
mapping the displayed intensity values to the captured intensity values; and
deriving the intensity function from the intensity value mappings.

4. The method described in claim 3 wherein displayed and captured intensity values are one of grayscale intensity values and color intensity values.

5. The method described in claim 3 further comprising determining a look-up table representative of the intensity function using interpolation.

6. The method described in claim 2 further comprising deriving the location function from coordinate mappings using a perspective transformation.

7. The method described in claim 6 further comprising displaying five or more calibration images and deriving the location function using a perspective transformation having nine associated coefficients for determining a two coordinate perspective transformation.

8. The method described in claim 1 further comprising comparing the expected captured display area data to the portion of the captured display area data corresponding to the predetermined location of the display area by:
subtracting pixel values of the expected captured display area data from corresponding pixel values of the captured display area data to obtain difference data at each coordinate location of the display area; and
for each coordinate location, comparing the difference data to a threshold noise value to identify the location of the objects in front of the display area.

9. The method as described in claim 8 wherein the threshold noise value is dependent on lighting conditions, type of image displayed, and camera quality.

10. The method as described in claim 1 wherein pixel values at non-matching locations of the captured display area data are set to a first intensity value and the remaining pixel values of the captured display area data are set to a second intensity value.

11. A method of calibrating a system including a computer controlled display area and an image capture area of an image capture device comprising:
displaying a plurality of calibration images within the display area each including a calibration object having an associated coordinate location within the display area;
capturing a plurality of images of the display area within the capture area each including one of the plurality of calibration images;
for each captured image, mapping the coordinate location of the calibration object in the display area to a coordinate location of the calibration object in the predetermined location of the display area in the capture area; and
deriving the location function from the coordinate location mappings.

12. The method described in claim 11 further comprising deriving the location function from the mappings using a perspective transformation.

13. The method described in claim 12 further comprising displaying five or more calibration images and deriving the location function using the perspective transformation having nine associated coefficients for determining a two coordinate perspective transformation.

14. The method as described in claim 11 further comprising deriving the intensity function by:
displaying at least two intensity calibration objects in at least one image within the display area each having a different associated displayed intensity value;
capturing the at least two displayed intensity calibration objects in the at least one image to obtain captured intensity values corresponding to the displayed intensity values;
mapping the displayed intensity values to the captured intensity values; and
deriving the intensity function from the intensity value mappings.

15. The method described in claim 14 further comprising determining a look-up table representative of the intensity function using interpolation.

16. A system comprising:
a computing system;
a display area controlled by the computing system to display an image in the display area having corresponding image data;
an image capture device for capturing the image within a capture area to obtain captured data that includes captured display area data corresponding to a predetermined location of the display area in the capture area;
an object locator including:
an image data converter for converting the displayed image data into expected captured display area data using a derived coordinate location function and a derived intensity function;
a means for comparing pixel values of coordinate locations of the expected captured display area data to corresponding coordinate locations in the captured display area data;
wherein non-matching compared image data corresponds to locations of non- displayed image objects in front of the display area.

17. The system as described in claim 16 wherein the coordinate mapping function is derived from the mappings using a perspective transformation.

18. The system as described in claim 16 wherein the display area is one of a projection screen and a computer monitor and the image capture device is one of a digital still camera, a digital video camera, an analog still camera, and an analog video camera.

19. The system as described in claim 16 further comprising a means for predetermining the location of the display area in the capture area by deriving constructive and destructive feedback data from image data corresponding to a plurality of captured calibration images.

20. An apparatus for locating an object in front of a display area in a user interactive, computer controlled display system including an image capture device having a corresponding capture area comprising:
a means for converting image data corresponding to an image displayed in the display area into expected captured display area data using a derived coordinate location function and a derived intensity function;
a means for comparing pixel values of coordinate locations of the expected captured display area data to corresponding coordinate locations in captured data corresponding to a predetermined location of the display area within the capture area;
wherein non-matching compared image data corresponds to locations of objects in front of the display area.

21. The apparatus as described in claim 20 wherein the means for comparing pixel values comprising:
a means for subtracting expected captured display area data pixel values from captured display area data to obtain a difference value for each pixel location of the displayed image;
a means for comparing the difference value to a threshold value;
wherein, for a given compared pixel location, if the absolute difference value is greater than the threshold value then an object is located in front of the given pixel location.

22. The apparatus as described in claim 21 wherein the threshold value is dependent on lighting conditions, type of image displayed, and camera quality.

23. The apparatus as described in claim 20 further comprising a means for predetermining the location of the display area in the capture area by deriving constructive and destructive feedback data from image data corresponding to a plurality of captured calibration images.
